(19) United States
(12) Patent Application Publication
(10) Pub. No.: US 2005/0103888 A1
(43) Pub. Date: May 19, 2005

(54) Sprinkler spacer and stake system

(76) Inventors: J. Craig Corbett, MountainView, WY (US); Natalie H. Corbett, MountainView, WY (US); Rene M. Roderer, Wellsville, UT (US)

Correspondence Address: Dean P. Edmundson, P.O. Box 179, Burton, TX, 77835, US

(21) Appl. No.: 10/989,800

(22) Filed: Nov. 16, 2004

Related U.S. Application Data
(60) Provisional application No. 60/523,497, filed on Nov. 19, 2003.

(51) Int. Cl. B05D 1/00

(52) U.S. Cl. 239/276; 239/201; 239/273

(57) ABSTRACT

A support system for supporting a sprinkler head which is connected to a water supply line. The support system includes a spacer body having inner and outer portions and is capable of being attached to a sprinkler head. The spacer includes a receiver extending above the upper surface of the spacer for receiving the upper end of an elongated stake member which extends downwardly from the spacer body to provide lateral support to the spacer body and the sprinkler head when the stake member is inserted into the ground.

### CROSS-REFERENCE TO RELATED APPLICATIONS

This application is based upon, and claims priority from, Provisional Application No. 60/523,497, filed Nov. 19, 2003. This application is also related to application Ser. No. 10/956,271, filed Oct. 1, 2004; application Ser. No. 10/626,910, filed Jul. 25, 2003; application Ser. No. 10/674,222, filed Sep. 29, 2003; and application Ser. No. 10/696,931, filed Oct. 30, 2003. This application is also related generally to U.S. Pat. No. 6,575,380, issued Jun. 10, 2003.

### FIELD OF THE INVENTION

This invention relates to sprinkler systems commonly used for sprinkling lawns or other landscaped areas. More particularly, this invention relates to installation techniques for sprinkler systems.

### BACKGROUND OF THE PRIOR ART

Typical sprinkler systems used for lawns and other landscaped areas include water supply lines which are placed below ground and extend from a main supply pipe to each sprinkler head. The sprinkler head extends upwardly to the upper surface of the ground. Typical sprinkler heads are of the “pop-up” style which extend upwardly above the grass when pressure is applied to the water in the supply line, and then the sprinkler head retracts when it is no longer in use. The top of the sprinkler head remains exposed at ground level. Some existing sprinklers are rotary sprinklers which expel water from the side of the sprinkler head when pressurized water from the supply line sprays in a rotary manner around the sprinkler. The top of the sprinkler head remains exposed at ground level. In many situations the action of water spraying from the side of the sprinkler in a rotary manner causes the sprinkler to have a propensity to shift backwards, towards the sidewalk, or move in the ground causing a cavity on the opposite side of the jetting water spray. Also, the act of edging and pulling dirt away from the side closest to the sidewalk causes the sprinkler to drift over time.

In some installations, the sprinkler head is connected to the water supply pipe with a flexible pipe. Although this enables the installer to more easily position the sprinkler head in a desired place, the flexible pipe provides little, if any, support to the sprinkler head (either lateral or vertical support). As a result, when soil is filled in around the sprinkler head, the sprinkler head can tilt to one side or the other, and the sprinkler head can also sink downwardly. When the sprinkler head is too close to a sidewalk, curb or other such object, the spinning metal blade of an edger can irreparably damage any sprinkler head which is too close to sidewalk, curb, etc. Then the sprinkler head must be replaced, at considerable time and expense. When using rotary heads, the cavity caused by the jetting spray or caused by edging on a regular basis can cause drifting because the sprinkler does not have the stability needed to hold it in place. With the sprinkler spacers properly installed, the stability is created to solve this problem.

U.S. Pat. No. 5,102,048 (Bohnhoff) describes an irrigation head support which is a circular mat with a plurality of concentric circular ribs connected by a plurality of radially extending ribs. There is an opening in the center of the mat for receiving an irrigation head. The mat also includes a plurality of upwardly extending rings which are spaced around the outer portion of the mat. The upper surface of such rings is to be placed at ground level when the mat and the irrigation head are installed (e.g. on a golf course). The purpose of the guard is said to be for protecting an irrigation head from vehicle tires and for preventing erosion of the soil surrounding the head. The circular mat was not designed or intended for use in connection with obtaining the proper spacing of sprinkler heads in lawns from sidewalks, curbs, etc. where edgers are used. Further, the circular mat was not designed for providing support to a sprinkler head attached to a flexible pipe.

U.S. Pat. No. 5,678,353 (Tsao et al.) describes a grass guard for preventing growth of any vegetation around a perimeter of an object (e.g. a sprinkler head). The grass guard is composed of two layers. The top layer is a plastic sheet simulating grass, and the bottom layer is made of heavy grit bonded into a uniform body with a polymer. The grass guard is shown as a circular mat which has a central opening for a sprinkler head to fit through. The grass guard is intended for use around existing sprinkler heads. Where a sprinkler head is already located adjacent to a sidewalk, for example, one side of the grass guard can be cut away. There is no description in the patent regarding use of the grass guard during installation of a sprinkler head to maintain proper position of the sprinkler head, and even if the grass guard was used, a lawn edger would still hit it while edging. Further, the patent does not describe use of the mat to provide lateral and vertical support to a sprinkler head connected to a flexible pipe.

U.S. Pat. No. 6,186,416 (Jones) describes a trim ring for use around a lawn sprinkler to discourage grass growth around it and to protect the sprinkler by indicating its location. The trim ring includes two complementary plates, each having a notch which, when assembled, forms a central aperture fitting around a sprinkler body. The overlapped plates are then secured to each other by screws. The patent does not describe use of the trim ring for positioning sprinkler heads during installation next to a sidewalk or curb, etc. Further, the patent does not refer to providing lateral or vertical support to a sprinkler head.

U.S. Pat. No. 4,146,181 (Soos) describes a guard ring for a lawn sprinkler. The guard ring includes a central sleeve for surrounding the upper portion of the sprinkler head, and a frustoconical skirt extends outwardly and downwardly from the upper edge of the sleeve. A plurality of stabilizing fins extends downwardly and outwardly from the periphery of the skirt. The guard ring is for protecting the sprinkler head from lawn mowers which drive over the sprinklers. The patent does not describe use of the guard ring for positioning of sprinkler heads adjacent to sidewalks, curbs, etc. Further, the patent does not describe providing lateral and vertical support to a sprinkler head connected to a flexible pipe.

U.S. Design Pat. No. D410,731 (Bowman et al.) shows a sprinkler head guard which appears to be a circular disk with an off-set opening extending through it. The apparent purpose of the guard is to protect the sprinkler head from the activity of conventional lawn mowers.

There has not heretofore been provided a system for effectively supporting a sprinkler head in a lawn, or other landscaped area, having the advantages provided by the present invention.

### SUMMARY OF THE INVENTION

In accordance with the present invention there is provided a system for supporting a sprinkler in the ground to prevent the sprinkler from tilting or leaning. The support system also includes a spacer to prevent the sprinkler from being positioned too close to a sidewalk, curb, etc. The support system preferably involves the use of a spacer or guide member which can be attached to the sprinkler body and which extends laterally outwardly an appropriate distance so that when the sprinkler is installed the sprinkler can be easily positioned a defined distance from a sidewalk, curb, etc. The spacer or guide serves to protect the sprinkler from being damaged by the metal blade of an edger passing between the edge of a sidewalk or curb and the sprinkler. The support system also includes a depth gauge or guide to assure that the spacer is positioned sufficiently below the top of the sprinkler to avoid contact with an edger. The support system of this invention is useful in conjunction with any type of sprinkler, whether stationary or rotary.

In one embodiment, the support system preferably includes opposing resilient fingers which are adapted to grip or fit partially around the tubular body of a sprinkler. The support system also preferably includes a vertically extending box or receiver portion which extends upwardly a predetermined distance to prevent the spacer from being positioned too high on the sprinkler body. It is preferred that the main portion of the spacer body be positioned at least about 1.5 to 3 inches below the rim of the sprinkler head so that the spacer is not contacted by a conventional lawn edger which is used to cut grass along a sidewalk, curb, etc. The box is open at the bottom to enable an elongated stake (preferably tapered at its lower end) to be slidably received within the box. The elongated stake extends downwardly in a generally perpendicular manner relative to the spacer body so as to provide lateral and vertical support to the sprinkler. Preferably the stake member extends a few inches below the lower end of the sprinkler head so that the stake member extends well into the ground during installation of the sprinkler head. The stake member keeps the sprinkler head in a vertical position and prevents the sprinkler head from leaning to one side before fill dirt can be placed properly around the sprinkler head and compacted. By supporting the sprinkler in the ground with the elongated stake, the sprinkler can be pressure-tested before the trench for the water line is filled in or closed. This is a huge advantage because if there is a water leak in the system, the leak can be repaired very quickly and easily. Also, the irrigation system can be observed to determine the area of coverage provided by each sprinkler, thus conserving water and avoiding future repairs.

The support system accordingly provides lateral and vertical support to the sprinkler head, yet it does not interfere with conventional lawn edging operations. The support system enables water, fertilizer, etc. to flow through it. Grass is able to grow upwardly through openings in the spacer body.

Other advantages and features of the system of this invention will be apparent from the following detailed description and accompanying drawings.

### BRIEF DESCRIPTION OF THE DRAWINGS

The invention is described in more detail hereinafter with reference to the accompanying drawings wherein:

FIG. 1 is a perspective view showing one embodiment of a spacer of this invention which is shown attached to a sprinkler head;

FIG. 2 is an exploded view showing the spacer of FIG. 1 and an elongated stake which is capable of being received in the spacer to provide a support system for a sprinkler head;

FIG. 3 shows a top plan view of the spacer shown in FIG. 1;

FIG. 3A is a cross-sectional view of the spacer taken along lines 3A-3A in FIG. 3; and

FIG. 4 is an elevational view showing the manner in which the spacer and stake support a sprinkler in the ground next to a sidewalk or curb, etc.

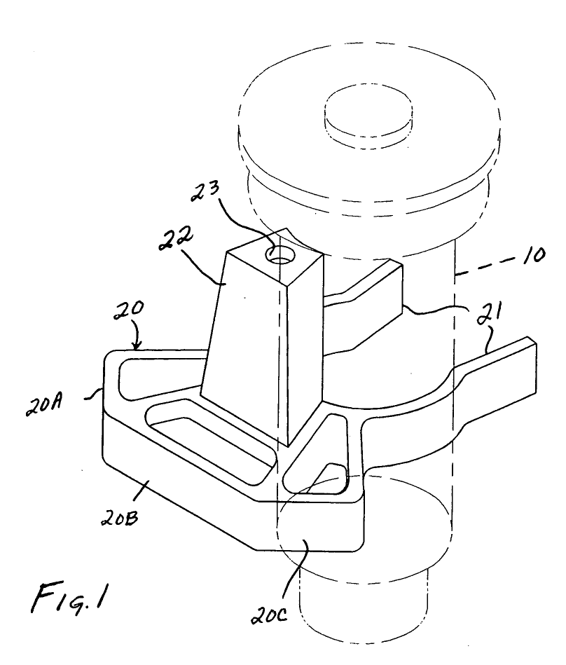

### DETAILED DESCRIPTION OF THE INVENTION

The drawings show a spacer 20 of the invention attached to a conventional sprinkler head 10. The spacer includes resilient finger clips 21 which are adapted to attach to the body of the sprinkler. The spacer body preferably includes outer lateral edges 20A, 20B and 20C which are at angles to each other, as shown. For example, edges 20A and 20C preferably are at an angle of 45 degrees relative to edge 20B. This enables the spacer to be positioned in close proximity to a sidewalk, curb, etc. or to an intersection of two sidewalks or curbs.

The spacer also preferably includes a box or receiver portion 22 which extends vertically upward from the upper surface of the spacer, as shown. The receiver is hollow so that the upper end 32 of elongated stake 30 can be slidably inserted into the lower end of receiver 22. If desired, the stake may include an outwardly projecting shoulder or ledge 33 below the upper end of the stake to limit the extent to which the upper end 32 may be forced into the receiver. The upper end of the receiver 22 may include an opening 23 to enable a tool to be used to push the stake out of the receiver, if desired. The spacer may be used without a stake.

The upper end of the receiver extends above the upper surface of the spacer body a predetermined distance (e.g. 1.5 to 3 inches). When the spacer is attached to a sprinkler, the upper surface of the receiver abuts the underside of the top of the sprinkler head. This assures that the spacer body will be positioned a predetermined distance below the surface of the ground in which the sprinkler is located. In other words, the receiver serves as a depth gauge for the spacer body to assure that it is located sufficiently below ground level that it will not be contacted by the metal blade of an edger.

The lower end 31 of the stake is preferably tapered to facilitate pushing it into the ground to support the spacer and the sprinkler. This then prevents the sprinkler from leaning or tilting to one side or the other. Because the sprinkler is supported in a stable manner, the irrigation system may be pressure tested even before the water line trenches are filled in or closed. Also, it enables the coverage provided by the irrigation system to be observed. Adjustments in the types of sprinklers required can be easily made before the system is buried. This can save a tremendous amount of time during installation of the irrigation system. The length and cross-sectional shape of the stake may vary, as desired.

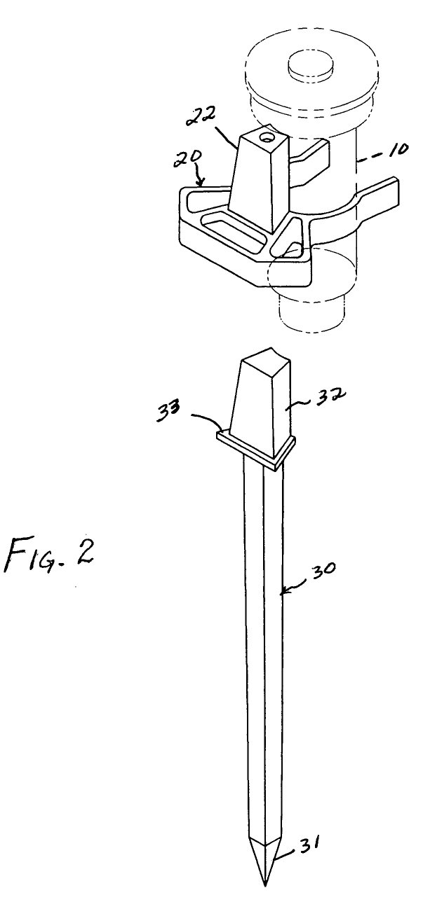

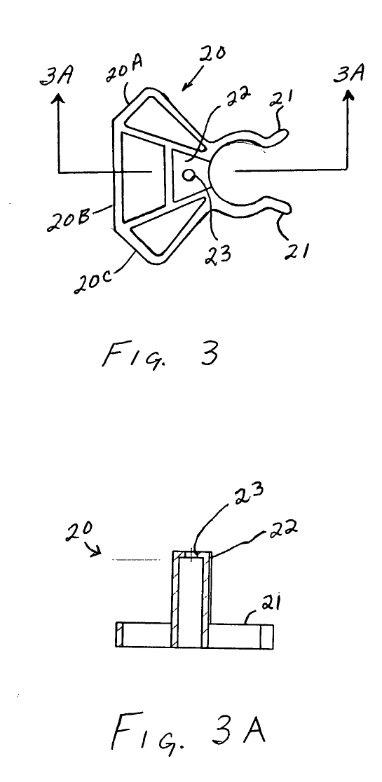

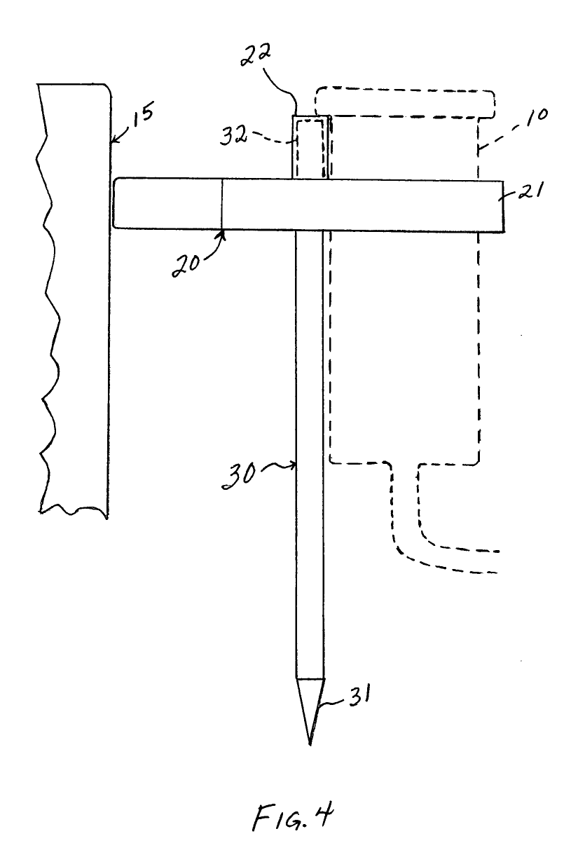

FIG. 3 is a top plan view of the spacer 20. The spacer includes a body portion, opposing resilient finger grips, and a receiver which extends upwardly from the body portion for slidably receiving an elongated stake member, e.g. of the type shown in FIGS. 2 and 4.

FIG. 4 is a side elevational view showing a spacer and stake being used to support a sprinkler at a predetermined distance from the edge 15 of a sidewalk, curb, etc. The spacer also has an elongated stake supported therein which holds the sprinkler in the ground and provides lateral and vertical support to the sprinkler.

The opposing finger clips of the spacer are resilient so that they may be urged apart in order for them to be slipped or snapped onto the cylindrical body of the sprinkler. The resilient grips then hold the spacer onto the sprinkler head and also allow the body portion to move vertically or rotationally relative to the sprinkler head after it has been attached.

The height of the receiver portion of the spacer determines the height at which the top of the sprinkler extends above the upper surface of the spacer body. In other words, the height of the receiver prevents the body portion of the spacer from being attached too high on the sprinkler body. This assures that the body portion of the spacer will be located at a sufficient depth below the surface of the ground (e.g. about 1.5 to 3 inches, for example) so that it will not be contacted by the spinning blade of a lawn edger during normal use.

Preferably the upper end of the stake member is sized such that it is held in frictional engagement within the receiver portion of the spacer body. Other means can also be used to attach the stake to the body of the spacer. If desired, the upper ends of the stake member and the receiver portion may be slightly tapered so that the upper end of the stake member becomes physically wedged into the receiver portion. Another advantage of the upright receiver portion 22 of the spacer 20 is that the top of the receiver portion provides a generally planar surface against which a hammer may be struck to force the stake 30 into the ground. When the receiver portion is struck with a hammer, the upper end of the stake becomes more tightly secured within the receiver portion. The longitudinal or central axis of the receiver portion is preferably perpendicular to the longitudinal axis of the spacer so that the stake member will be generally perpendicular to the spacer body, as shown in FIGS. 2 and 4.

Preferably, the spacer body member includes three exterior or outer vertical surfaces or edges 20A, 20B and 20C, as shown. One or more of these vertical surfaces or edges are used to determine the proper placement of a sprinkler head next to a sidewalk, curb, etc. The vertical edges prevent the sprinkler head from being positioned too close to the edge of a sidewalk, for example, or too close to the intersection of sidewalks or the like.

The support system of the invention thus enables a sprinkler head to be easily and simply positioned and supported during installation. Because the sprinkler head is properly supported, testing of the system can be done before the trenches are closed. Also, the coverage of the irrigation system can be observed to determine whether different types of sprinklers will be needed before the water lines are buried and the trenches filled.

The spacer and stake of this invention can be composed of any desired material. Normally they are composed of a plastic material because of economics and because it is light in weight. Various conventional plastics are suitable. Metal, wood, ceramic, fiberglass or composite materials could also be used. The sizing and styling of the spacer and stake could also vary and they can be made to accommodate any diameter of sprinkler head.

Other variants are possible without departing from the scope of this invention.

1. A support system for supporting a sprinkler head in the ground, the system comprising:
(a) a spacer body having an outer peripheral portion and an inner portion; wherein said spacer body further includes a receiver portion extending above said body;
(b) attachment means for attaching said spacer body to said sprinkler head; and
(c) an elongated stake member adapted to be received in said receiver portion of said spacer body; wherein said stake member extends downwardly from said spacer body and provides lateral support to said spacer body and said sprinkler head in the ground.

2. A support system in accordance with claim 1, wherein said stake member is detachable from said receiver portion of said spacer body.

3. A support system in accordance with claim 1, wherein said stake member is tapered along its length.

4. A support system in accordance with claim 1, wherein said outer peripheral portion and said inner portion are joined by spaced vertical ribs which define openings through said spacer body.

5. A support system in accordance with claim 1, wherein said outer peripheral portion extends outwardly a predetermined distance so as to enable said sprinkler head to be positioned adjacent to a sidewalk or curb with a spacing at least equal to said predetermined distance.

6. A support system in accordance with claim 1, wherein said attachment means comprises resilient finger grips for gripping said sprinkler head.

7. A support system in accordance with claim 1, wherein said sprinkler head includes an outwardly extending rib, and wherein the height of said receiver portion determines the spacing between the upper surface of said spacer body and the top of said sprinkler head.

8. A method for supporting a sprinkler at a predetermined distance from the edge of a sidewalk or curb, the method comprising the steps of:
(a) providing a spacer body having an outer peripheral portion and an inner portion; wherein said spacer body further includes a receiver portion extending above said body;
(b) attaching said spacer body to said sprinkler;
(c) inserting an elongated stake into said receiver portion of said spacer body; wherein said stake extends downwardly from said spacer body; and
(d) inserting said stake into the ground in a manner such that said spacer body is adjacent to said sidewalk or curb and said spacer body provides a spacing between said sprinkler and said sidewalk or curb which is at least equal to said predetermined distance.

9. A method in accordance with claim 8, wherein said outer peripheral portion includes at least three vertical edges;
wherein two of said edges are at an angle of 45 degrees relative to the other of said edges.

10. A method in accordance with claim 8, wherein said receiver portion comprises upright side walls and a generally planar top surface; wherein said receiver portion defines a cavity for slidably receiving the upper end of said stake.

11. A method for testing an irrigation system comprising a plurality of sprinklers connected to a water line in a trench in the ground, the method comprising the steps of:
(a) providing a plurality of elongated stake members;
(b) providing a plurality of spacers, each of which includes a receiver portion;
(c) attaching one of said spacers to each of said sprinklers;
(d) attaching one of said stake members to said receiver portion of each said spacer;
(e) inserting each said stake member into the ground in a manner such that each said sprinkler is supported laterally and vertically in the ground;
(f) introducing water under pressure to said water line;
(g) observing said sprinklers to determine whether said sprinklers are operating properly and are providing desired irrigation coverage.
